(19) United States
(12) Patent Application Publication
(10) Pub. No.: US 2020/0192546 A1
(43) Pub. Date: Jun. 18, 2020

(54) DISPLAY DEVICE, MACHINE TOOL AND ABNORMALITY DETERMINATION METHOD

(71) Applicant: FANUC CORPORATION, Yamanashi (JP)

(72) Inventors: Takaaki Itou, Yamanashi-ken (JP); Yoshito Miyazaki, Yamanashi-ken (JP)

(73) Assignee: FANUC CORPORATION, Yamanashi (JP)

(21) Appl. No.: 16/712,403

(22) Filed: Dec. 12, 2019

(30) Foreign Application Priority Data
Dec. 14, 2018 (JP) 2018-234694

(51) Int. Cl. G06F 3/041; G06F 3/044; G06F 3/0488; G06F 3/0481

(52) U.S. Cl. CPC G06F 3/04186; G06F 3/04817; G06F 3/04886; G06F 3/0446

(57) ABSTRACT

A display device includes: a display panel displaying an image; a touch panel including plural nodes arranged in a matrix on the display panel along an X direction and a Y direction intersecting the X direction to detect a touch position in the X and Y directions; a display controller for displaying plural operation buttons on the display panel so as not to overlap each other in the X and Y directions of the touch panel; a storage storing coordinate information indicating coordinates on the touch panel of each of the plural operation buttons; and a determination unit which examines, based on the coordinate information, whether or not the operation button corresponding to the touch position in the X direction coincides with the one corresponding to the touch position in the Y direction and determines that an abnormality has occurred when the operation buttons do not coincide.

### CROSS-REFERENCE TO RELATED APPLICATION

This application is based upon and claims the benefit of priority from Japanese Patent Application No. 2018-234694 filed on Dec. 14, 2018, the contents of which are incorporated herein by reference.

### BACKGROUND OF THE INVENTION

### Field of the Invention

The present invention relates to a display device, a machine tool and an abnormality determination method for grasping an abnormality on a touch panel.

### Description of the Related Art

In some cases, redundancy may be used in preparing an event of some failure in a part of the system such that the functions of the entire system can be maintained even after a failure occurs. Internal Publication No. WO2015/146277 discloses a touch panel in which two wirings connected in parallel to electrodes arranged in the X-axis direction are connected by a first redundant line while two wirings connected in parallel to electrodes arranged in the Y-axis direction are connected to a second redundant line so as to restrain occurrence of a detection failure of a touch position.

### SUMMARY OF THE INVENTION

However, the touch panel disclosed in Internal Publication No. WO2015/146277 requires additional wirings for redundancy, which cannot be used for existing touch panels.

It is therefore an object of the present invention to provide a display device, a machine tool, and an abnormality determination method, capable of grasping an abnormality without using redundancy in a touch panel.

A first aspect of the invention resides in a display device comprising: a display panel displaying an image; a touch panel including a plurality of nodes arranged in a matrix on the display panel along an X direction and a Y direction intersecting the X direction and configured to detect a touch position in the X direction and the Y direction; a display controller configured to display a plurality of operation buttons on the display panel so as not to overlap each other in the X direction and the Y direction of the touch panel; a storage storing coordinate information indicating coordinates on the touch panel of each of the plurality of operation buttons; and a determination unit configured to examine, based on the coordinate information stored in the storage, whether or not the operation button corresponding to the touch position in the X direction coincides with the operation button corresponding to the touch position in the Y direction and determine that an abnormality has occurred when the operation buttons do not coincide.

A second aspect of the present invention resides in a machine tool including the above display device.

A third aspect of the present invention resides in an abnormality determination method for determining abnormality of a touch panel which includes a plurality of nodes arranged in a matrix on a display panel along an X direction and a Y direction intersecting the X direction to detect a touch position in the X direction and the Y direction. The abnormality determination method includes: a display step of displaying a plurality of operation buttons on the display panel so as not to overlap each other in the X direction and the Y direction of the touch panel; and a determination step of examining, based on coordinate information indicating coordinates on the touch panel of each of the plurality of operation buttons, whether or not the operation button corresponding to the touch position in the X direction coincides with the operation button corresponding to the touch position in the Y direction, and determining that an abnormality has occurred when the operation buttons do not coincide.

According to the present invention, it is possible to grasp an abnormality caused by failure of the touch panel or human error when touching, without providing redundancy to the touch panel.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing a configuration of a display device;

FIG. 2 is a conceptual diagram showing an example of display displayed on a display panel;

FIG. 3 is a flowchart illustrating a processing flow in a signal processing unit;

FIG. 4 is a conceptual diagram showing an example of display displayed on a display panel in Modification 1;

FIG. 5 is a conceptual diagram showing an example of display displayed on a display panel in Modification 2;

FIG. 6 is a block diagram showing a configuration of a display device according to Modification 2;

FIG. 7 is a flowchart illustrating a processing flow in a signal processing unit of Modification 2;

FIG. 8 is a diagram showing a part of a display device of Modification 3; and

FIG. 9 is a block diagram showing a part of a display device of Modification 4.

### DESCRIPTION OF THE PREFERRED EMBODIMENTS

The present invention will be detailed below by describing preferred embodiment with reference to the accompanying drawings.

### Embodiment

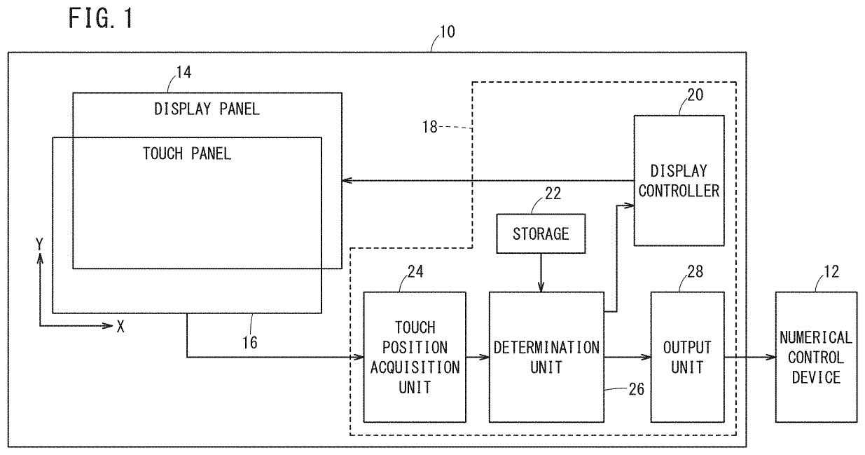

FIG. 1 is a block diagram showing a configuration of a display device 10. In the present embodiment, the display device 10 is used in a machine tool. The machine tool is to machine a workpiece by using a tool or electrical discharge, and includes the display device 10 and a numerical control device 12.

The display device 10 includes a display panel 14, a touch panel 16 and a signal processor 18. The display panel 14 is a liquid crystal display or the like, having a display screen. The display panel 14 displays various kinds of information on the screen based on display control signals given from the signal processor 18.

The touch panel 16 is a transparent film-like or glassy member attached on the screen of the display panel 14. In FIG. 1, for convenience, the display panel 14 and the touch panel 16 are shown in an offset manner.

The touch panel 16 has a plurality of nodes arranged in a matrix on the display panel 14, along the X direction that is the first direction and the Y direction that is the second direction that intersects the first direction. Each node represents a coordinate point of the matrix. The touch panel 16 detects a node touched by a user's finger or stylus as a touch position (Xm, Yn), and outputs a signal indicating the detected touch position.

The signal processor 18 is a computer having at least a processor such as a CPU and a memory such as a register. The processor runs a program stored in the memory to provide the functions of a display controller 20, a storage 22, a touch position acquisition unit 24, a determination unit 26 and an output unit 28.

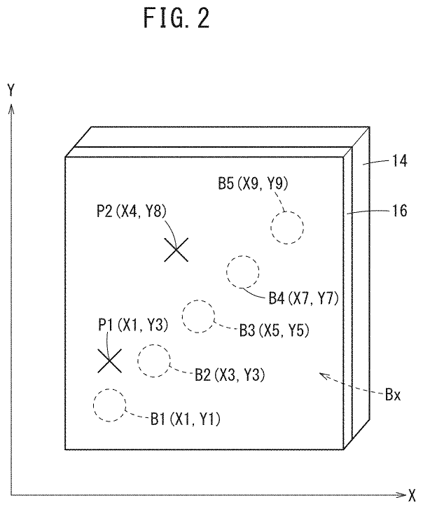

The display controller 20 controls the display panel 14. FIG. 2 is a conceptual diagram illustrating a display example displayed on the display panel 14. The display controller 20 displays a plurality of operation buttons Bx that causes the numerical control device 12 to execute processing, in such a manner that the buttons do not overlap each other with respect to the X direction and the Y direction of the touch panel 16.

Since the plural operation buttons Bx (B1 to B5) do not overlap with each other in the X direction and the Y direction of the touch panel 16, they are arrayed diagonally with respect to the X direction and the Y direction. That is, each of the plural operation buttons Bx has a one-to-one correspondence with the X coordinate and the Y coordinate on the touch panel 16, and each of the operation buttons Bx has either one or plural adjacent coordinate points (X coordinate, Y coordinate) on the touch panel 16 uniquely.

The plural operation buttons Bx include an operation button B1 with coordinates (X1, Y1) on the touch panel 16, an operation button B2 with coordinates (X3, Y3) on the touch panel 16, an operation button B3 with coordinates (X5, Y5) on the touch panel 16, an operation button B4 with coordinates (X7, Y7) on the touch panel 16, and an operation button B5 with coordinates (X9, Y9) on the touch panel 16. The storage 22 stores coordinate information indicating the coordinate point of each of the plural operation buttons Bx on the touch panel 16. This coordinate information may be stored beforehand or may be stored by the display controller 20.

The touch position acquisition unit 24 acquires a touch position (Xm, Yn) based on the signal output from the touch panel 16. Based on the coordinate information stored in the storage 22 and the touch position (Xm, Yn) acquired by the touch position acquisition unit 24, the determination unit 26 determines whether or not there is an abnormality that is caused by a failure of the touch panel 16 or a human error when touching.

Here, as shown in FIG. 2, it is assumed that the operation button B1 is a touch target and that the operation button B1 is touched correctly. In this case, a touch position (X1) in the X direction corresponds to the operation button B1 and a touch position (Y1) in the Y direction also corresponds to the same operation button B1.

On the other hand, it is assumed that the operation button B1 is a touch target but the position P1 (X1, Y3) on the touch panel 16 is detected as the touch position due to a failure of the touch panel 16 or a human touch error. In this case, the touch position (X1) in the X direction corresponds to the operation button B1 whereas the touch position (Y3) in the Y direction corresponds to another button, i.e., the operation button B2. That is, the operation buttons B1 and B2 corresponding to the touch position (X1, Y3) are different.

Further, it is assumed that the operation button B1 is a touch target but the position P2 (X4, Y8) on the touch panel 16 is detected as the touch position due to a failure of the touch panel 16 or a human touch error. In this case, there is no operation button corresponding to the touch position (X4) in the X direction, and there is no operation button corresponding to the touch position (Y8) in the Y direction. That is, there is no operation button corresponding to the touch positions (X4, Y8) at all, so that the same button does not exit.

In the above way, the determination unit 26, based on the coordinate information stored in the storage 22, examines whether the operation button corresponding to the touch position (Xm) in the X direction is identical with the operation button corresponding to the touch position (Yn) in the Y direction. Here, when the operation buttons corresponding to the touch position (Xm, Yn) correspond to the same operation button B1, for example, the determination unit 26 determines that the operation button B1 is correctly touched.

On the other hand, when the operation buttons corresponding to the touch positions (Xm, Yn) are not identical, the determination unit 26 determines that an abnormality is taking place due to a failure of the touch panel 16 or a human touch error. In this case, the display controller 20 displays a notice of occurrence of an abnormality on the display panel 14 in an area other than the display area of the plural operation buttons Bx. Thus, the user can recognize that the touch panel 16 is out of order when no touch mistake has been made.

The output unit 28 outputs an operation signal indicating the fact of operation to the outside. That is, when the determination unit 26 determines that the operation button B1 has been corrected touched, the output unit 28 generates an operation signal indicating that the operation button B1 has been operated and outputs the generated operation signal to the numerical control device 12. In this case, when receiving the operation signal, the numerical control device 12 executes the process assigned to the operation button B1. The output unit 28 outputs no operation signal when the determination unit 26 determines that an abnormality has occurred.

Additionally, even in a case where it has been determined that an abnormality is occurring because the two operation buttons corresponding to a touch position (Xm, Yn) do not coincide with each other, if one of the operation buttons is a specific operation button that executes a process for improving safety, it is preferable to execute the process. Examples of the specific operation buttons include an emergency stop button for stopping an industrial machine, a door stop button for stopping the opening and closing of a door of a protective cover that covers a robot, a machine tool, and the like.

For example, as described above, in a case where one of the operation buttons B1 and B2 corresponding to the touch position P1 (X1, Y3) is a specific operation button, the output unit 28 outputs to the numerical control device 12 an operation signal indicating that the specific operation button has been operated, even when it has been determined that an abnormality is occurring. Thereby, even if an abnormality resulting from a failure of the touch panel 16 or a human touch error has occurred, it is possible to assign a priority to the safe operation.

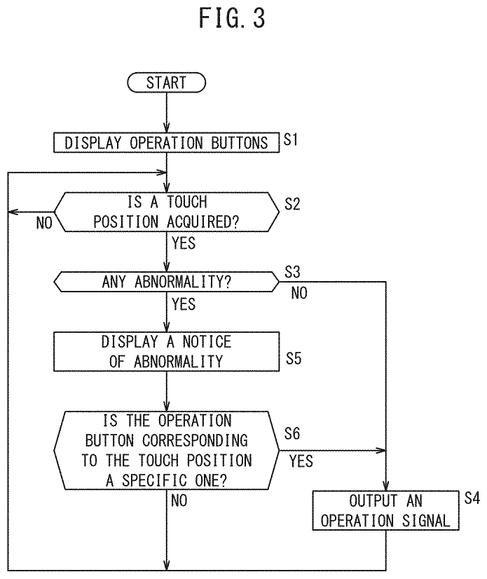

Next, an abnormality determination method for determining an abnormality in the display device 10 will be described. FIG. 3 is a flowchart showing a processing flow of the signal processor 18.

At step S1, the display controller 20 displays a plurality of operation buttons Bx on the display panel 14 such that the operation buttons will not overlap each other in the X direction and the Y direction of the touch panel 16. Then, the control proceeds to step S2.

At step S2, the touch position acquisition unit 24 determines whether or not a touch position (Xm, Yn) has been acquired. When no touch position (Xm, Yn) is acquired, the touch position acquisition unit 24 stands by, and when a touch position (Xm, Yn) is acquired, the control proceeds to step S3.

At step S3, the determination unit 26 examines based on the coordinate information stored in the storage 22, whether the operation button corresponding to the touch position (Xm) in the X direction and the operation button corresponding to the touch position (Yn) in the Y direction coincides with each other.

When the operation buttons corresponding to the touch positions (Xm, Yn) are the same, the determination unit 26 determines that the operation button is correctly touched, and the control proceeds to step S4. At step S4, the output unit 28 generates an operation signal indicating that, for example, a touch operation of the operation button B1 determined to have been correctly touched at step S3 has been made, and outputs the generated operation signal to the numerical control device 12, then the control returns to step S2.

On the other hand, when the operation buttons corresponding to the touch positions (Xm, Yn) do not coincide, the determination unit 26 determines that an abnormality occurs due to a failure of the touch panel 16 or a human touch error, and the control proceeds to step S5. At step S5, the display controller 20 displays a notice of occurrence of an abnormality on the display panel 14 in a region other than the display region of the plural operation buttons Bx, and the control proceeds to step S6.

At step S6, the output unit 28 recognizes whether one of the operation buttons corresponding to the touch position (Xm, Yn) checked by the determination unit 26 at step S3 is a specific operation button.

Here, when one of the operation buttons corresponding to the touch position (Xm, Yn) is a specific operation button, the output unit 28 goes to step S4, and generates an operation signal indicating that the specific operation button has been operated, and outputs the generated operation signal to the numerical control device 12. Then, the control returns to step S2.

On the other hand, if neither of the operation buttons corresponding to the touch position (Xm, Yn) is a specific operation button, the control returns to step S2 without any output of an operation signal from the output unit 28.

As described above, the display device 10 displays plural operation buttons Bx on the display panel 14 such that they will not overlap each other in the X direction and the Y direction of the touch panel 16. When the operation buttons corresponding to the touch position (Xm, Yn) do not coincide with each other, it is determined that there is an abnormality. Thereby, without applying redundancy to the touch panel 16, an abnormality caused by a failure of the touch panel 16 or a human touch error can be grasped.

### Modifications

The above embodiment may be modified as in the following modifications.

### Modification 1

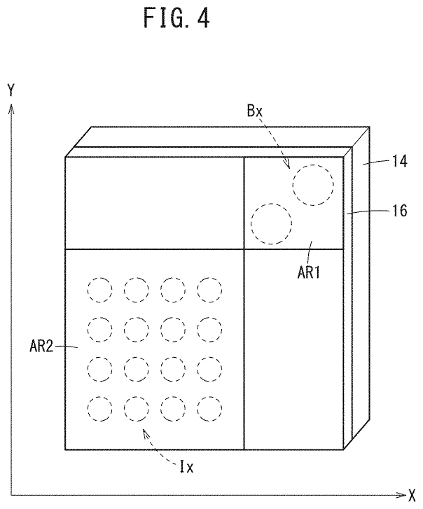

FIG. 4 is a conceptual diagram showing a display example displayed on the display panel 14 in Modification 1. Here, the same components as those described in the above embodiment are allotted with the same reference numerals, and the description which overlaps with the above embodiment is omitted.

In Modification 1, the display controller 20 displays a plurality of operation buttons Bx in a first area AR1 on the display panel 14 and displays one or more operation icons Ix in a second area AR2 thereon which does not overlap the first area AR1 with respect to the X direction and the Y direction.

This configuration makes it possible to use the second area AR2 of the touch panel 16 normally while grasping an abnormality caused by a failure of the touch panel 16 or a human touch error without applying redundancy to the touch panel 16 in the first area AR1.

### Modification 2

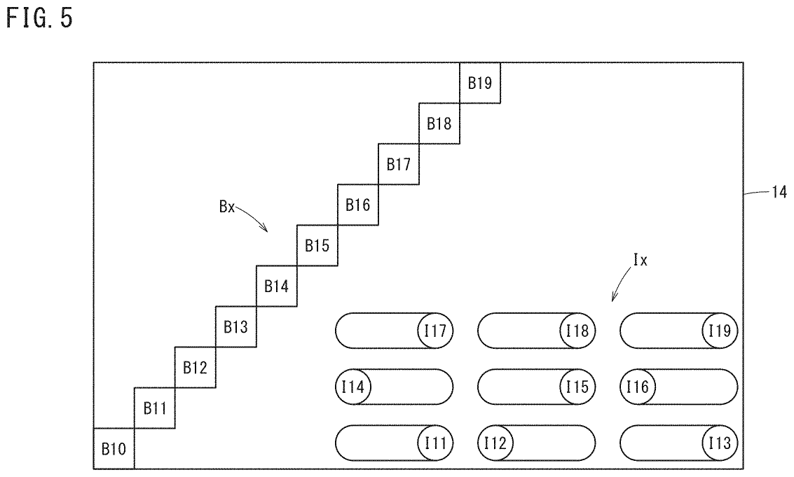

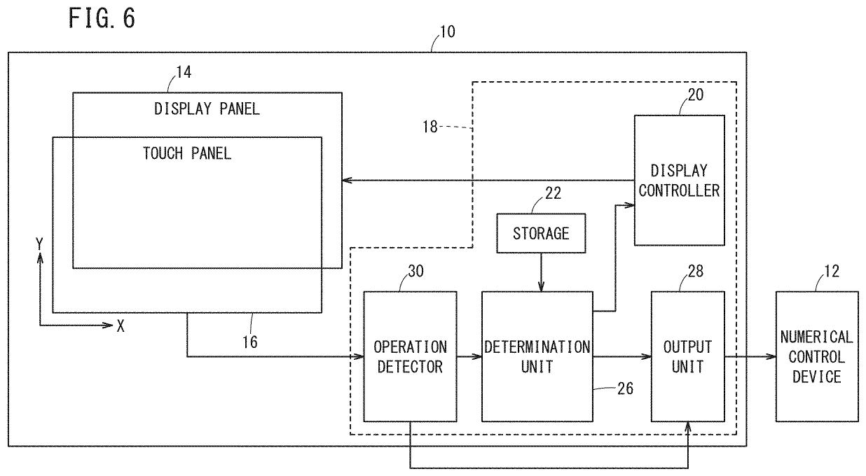

FIG. 5 is a conceptual diagram showing a display example displayed on the display panel 14 in Modification 2. FIG. 6 is a block diagram showing a configuration of a display device 10 of Modification 2. Here, the same components as those described in the above embodiment are allotted with the same reference numerals, and the description which overlaps with the above embodiment is omitted.

In Modification 2, the display controller 20 displays one or more operation icons Ix on the display panel 14 separately from plural operation buttons Bx (B10 to B19). In the example of FIG. 5, the operation icons Ix are plural operation icons I11 to 119. The operation icon Ix overlaps at least one of the plurality of operation buttons Bx in the X direction or the Y direction.

Here, when at least one of the plural operation buttons Bx overlaps with one or more operation icons Ix in the X direction or the Y direction, the signal processor 18 cannot distinguish between the operation icon Ix and the operation button Bx overlapped with the operation icon Ix. Specifically, for example, if an operation button B10 is correctly touched, it is impossible to determine whether or not an abnormality is occurring due to a failure of the touch panel 16 or a human touch error because there are operation icons I11 to I13 on the line extended from the operation button B10 in the X direction.

To deal with this, in the signal processor 18 of Modification 2, an operation detector 30 is provided instead of the touch position acquisition unit 24 of the above embodiment, as shown in FIG. 6. The operation detector 30 distinguishes the operation with an operation icon and the operation with an operation button by detecting the operating action.

For example, the operation detector 30, based on a signal output from the touch panel 16, distinguishes a click action and a swipe action. Specifically, the operation detector 30 detects the presence or absence of movement of the touch position (Xm, Yn) in unit time. When the detection result indicating no movement of the touch position (Xm, Yn) is obtained, the touch position (Xm, Yn) is given to the determination unit 26. In this case, the determination unit 26 checks whether the operation buttons corresponding to the touch position (Xm, Yn) coincide with each other based on the coordinate information stored in the storage 22 as in the above embodiment. If they are not identical, the determination unit 26 determines that there is an abnormality.

On the other hand, when detecting a movement of the touch position (Xm, Yn), for example, the operation detector 30 notifies the output unit 28 of an action to the operation icon I11 corresponding to the movement of the touch position (Xm, Yn). In this case, the output unit 28 generates an operation signal indicating that the operation icon I11 has been operated, and outputs the generated operation signal to the numerical control device 12.

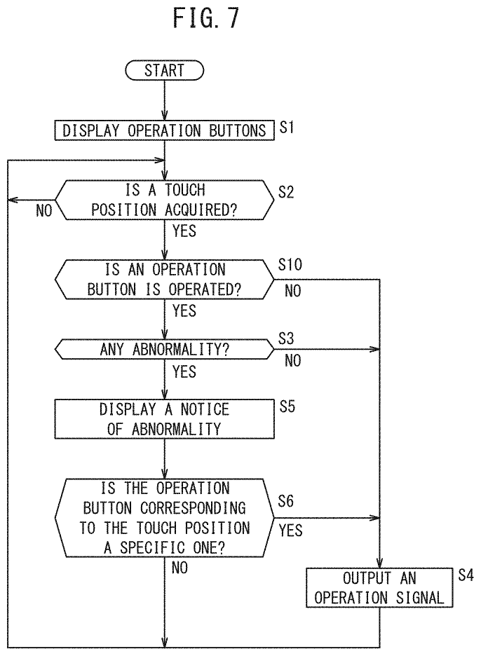

FIG. 7 is a flowchart showing a processing flow of the signal processor 18 in Modification 2. In Modification 2, the details of processing at steps S1 and S4 are different, and a new step S10 is added between steps S2 and S3.

At step S1, the display controller 20 displays a plurality of operation buttons Bx and one or more operation icons Ix at predetermined positions on the display panel 14, and proceeds to step S2. At step S2, when the operation detector 30 acquires a touch position (Xm, Yn), the control proceeds to step S10.

At step S10, the operation detector 30, based on the signal output from the touch panel 16, detects whether the touch operation is an operation (click action) to one of the operation buttons Bx or an operation (swipe action) to one or more operation icons Ix.

At this stage, when, for example, the operation detector 30 detects an operation (swipe action) to the operation icon I11, the operation detector 30 notifies the output unit 28 that the operation icon I11 has been operated, and the control proceeds to step S4. At step S4, the output unit 28 generates an operation signal indicating that the operation icon I11 has been operated, outputs the generated operation signal to the numerical control device 12, and then the control returns to step S2.

On the other hand, if the operation detector 30 detects an operation (click operation) to any of the operation buttons Bx, the control proceeds to step S3. In this case, the control proceeds in the same manner as in the above embodiment.

As described above, in Modification 2, the operation detector 30 distinguishes and detects the operation with the operation icon Ix and the operation with the operation button Bx based on the movement of the touch position, whereby the touch panel 16 can provide the function of grasping abnormalities, still being used as an ordinary touch panel 16 without having redundancy.

### Modification 3

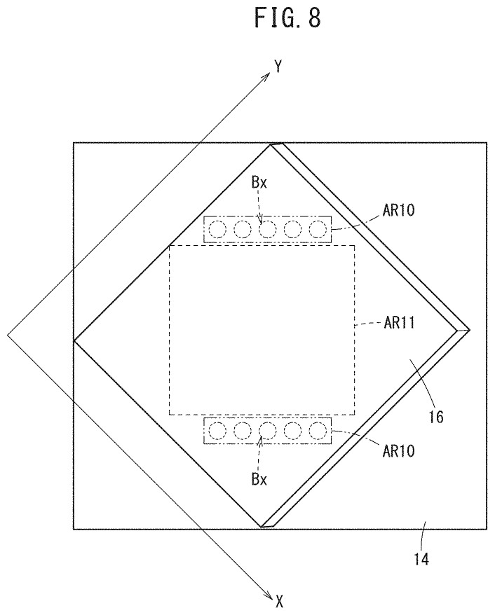

FIG. 8 is a diagram showing a part of a display device 10 according to Modification 3. In Modification 3, a touch panel 16 has a plurality of operation buttons Bx arranged in the longitudinal direction (along a long side) or the lateral direction (along a short side) of a display panel 14 having a rectangular configuration.

In other words, the touch panel 16 is disposed on the display panel 14 such that the X direction and the Y direction of the touch panel are not parallel to the longitudinal direction and the lateral direction of the display panel 14, and a display controller 20 is configured to display a plurality of operation buttons Bx along the longitudinal direction or the lateral direction of the display panel 14.

In this way, in Modification 3, the plural operation buttons Bx are arranged along the longitudinal direction or the lateral direction of the display panel 14, so that the operation buttons can be used easily and intuitively.

On the display panel 14, a display area AR10 that overlaps the plural operation buttons Bx and a specific display area AR11 that overlaps the touch panel 16 other than the plural operation buttons Bx may be made visible while the display areas other than the visible areas may be covered with a shading cover or the like. Alternatively, on the display screen of the display panel 14, the display area that does not overlap with the touch panel 16 may be covered with a shading cover or the like.

### Modification 4

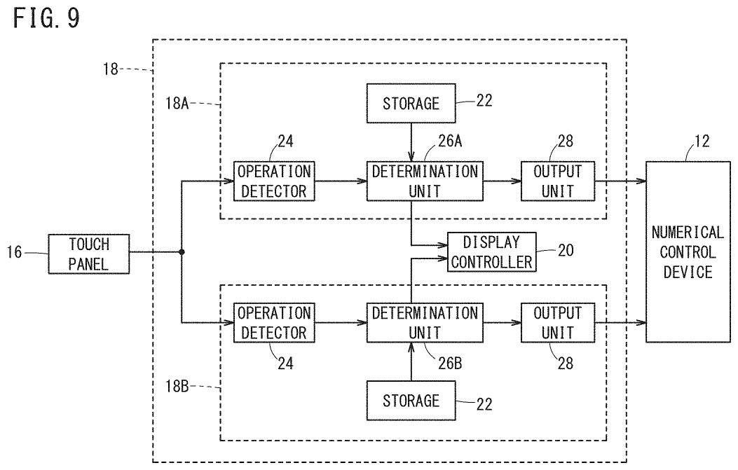

FIG. 9 is a block diagram showing a part of a display device 10 according to Modification 4. Here, the same components as those described in the above embodiment are allotted with the same reference numerals, and the description which overlaps with the above embodiment is omitted.

In Modification 4, the processing system in the signal processor 18 is duplicated. Specifically, the signal processor 18 includes a first processor 18A that performs processing on the touch position (Xm) in the X direction and a second processor 18B that performs processing on the touch position (Yn) in the Y direction.

The first processor 18A includes the same storage 22, touch position acquisition unit 24 and output unit 28 as those in the above embodiment, and a determination unit 26A different from the determination unit 26 in the above embodiment. The second processor 18B includes the same storage 22, touch position acquisition unit 24 and output unit 28 as those in the above embodiment, and a determination unit 26B different from the determination unit 26 in the above embodiment.

The determination unit 26A checks the operation button corresponding to the touch position (Xm) in the X direction based on the coordinate information stored in the storage 22, and examines whether or not the operation button coincides with the operation button corresponding to the touch position (Yn) in the Y direction, checked by the determination unit 26B.

On the other hand, the determination unit 26B checks the operation button corresponding to the touch position (Yn) in the Y direction based on the coordinate information stored in the storage 22, and examines whether or not the operation button coincides with the operation button corresponding to the touch position (Xm) in the X direction, checked by the determination unit 26A.

When the operation buttons corresponding to the touch position (Xm, Yn) are identical, the determination units 26A and 26B determine that the operation button is correctly touched, as in the above embodiment. On the other hand, when the operation buttons corresponding to the touch position (Xm, Yn) are not identical, the determination units 26A and 26B determine that there is an abnormality, as in the above embodiment.

When the processing of the first processor 18A is disabled, no operation button is confirmed at determination unit 26A even if the determination unit 26B of the second processor 18B confirms the operation button corresponding to the touch position (Yn) in the Y direction. That is, the operation buttons corresponding to the touch positions (Xm, Yn) do not coincide. Similarly, when the processing of the second processor 18B is disabled, the operation buttons corresponding to the touch positions (Xm, Yn) do not coincide. Therefore, in Modification 4, when one of the first processor 18A and the second processor 18B is disabled, it can also be determined that an abnormality has occurred.

As described above, in the case where the processing system of the signal processor 18 is duplicated, it is possible, as in the above embodiment, to grasp an abnormality caused by a failure of the touch panel 16 or a human touch error, without applying redundancy to the touch panel 16. In addition, since the processing system of the signal processor 18 is duplicated, safety can be further improved.

In Modification 4, when receiving both of an operation signal output from the output unit 28 of the first processor 18A and another operation signal output from the output unit 28 of the second processor 18B, the numerical control device 12 effects the process assigned to the operation button B1, for example, specified by the operation signals.

### Modification 5

In the above embodiment, the signal processor 18 is provided in the display device 10. However, all or part of the signal processor 18 may be provided in the numerical control device 12.

### Modification 6

The above embodiment and Modifications 1 to 5 may be arbitrarily combined as long as no contradiction occurs.

### Invention Obtained from Embodiment and Modifications

The inventions that can be grasped from the embodiment and the modifications will be described below.

### First Aspect of the Invention

The first aspect of the invention is a display device (10) that includes: a display panel (14) displaying an image; a touch panel (16) including a plurality of nodes arranged in a matrix on the display panel (14) along the X direction and the Y direction intersecting the X direction and configured to detect a touch position (Xm, Yn) in the X direction and the Y direction; a display controller (20) configured to display a plurality of operation buttons (Bx) on the display panel (14) so as not to overlap each other in the X direction and the Y direction of the touch panel (16); a storage (22) storing coordinate information indicating the coordinates on the touch panel (16) of each of the plurality of operation buttons (Bx); and a determination unit (26) configured to examine, based on the coordinate information stored in the storage (22), whether or not the operation button corresponding to the touch position (Xm) in the X direction coincides with the operation button corresponding to the touch position (Yn) in the Y direction and determine that an abnormality has occurred when the operation buttons do not coincide.

Thus, it is possible to grasp an abnormality caused by a failure of the touch panel (16) or a human touch error without providing redundancy to the touch panel (16).

The display controller (20) may cause the display panel (14) to display a notice indicating occurrence of the abnormality when it is determined that the abnormality has occurred. Thereby, the user can recognize that it is a failure of the touch panel (16) when no touch mistake is made.

The display device (10) may further include: an output unit (28) configured to, when the operation button corresponding to the touch position (Xm) in the X direction coincides with the operation button corresponding to the touch position (Yn) in the Y direction, output to the outside an operation signal indicating that the operation button has been operated. Thereby, it is possible to execute a process assigned to the operation button that has been normally touched.

The output unit (28) may be configured such that when it is determined that an abnormality has occurred and when one of the operation button corresponding to the touch position (Xm) in the X direction and the operation button corresponding to the touch position (Yn) in the Y direction is a specific operation button, the output unit (28) may output to the outside an operation signal indicating that the specific operation button has been operated. As a result, the control assigned to the specific operation button can be executed to assure safe conditions even if an abnormality occurs due to a failure of the touch panel (16) or a human touch error.

The display controller (20) may be configured to display the plurality of operation buttons (Bx) in a first area (AR1) on the display panel (14) and one or more operation icons (Ix) in a second area (AR2) on the display panel (14), the second area (AR2) being arranged so as not to overlap the first area (AR1) with respect to each of the X direction and the Y direction. This configuration enables normal use the second area (AR2) of the touch panel (16) while grasping an abnormality caused by a failure of the touch panel (16) or a human touch error without applying redundancy to the touch panel (16) in the first area (AR1).

The display controller (20) may be configured to display one or more operation icons (Ix) on the display panel (14), separately from the plurality of operation buttons (Bx), and the display device (10) may further include an operation detector (30) configured to detect an operation by distinguishing the operation with the operation icons and the operation with the operation buttons, based on the touch position (Xm, Yn). This configuration enables normal use the touch panel (16) while grasping abnormality without applying redundancy to the touch panel (16).

The display panel (14) may have a rectangular configuration while the touch panel (16) may be placed in a manner that the plurality of operation buttons (Bx) are arranged in the longitudinal direction or the lateral direction of the display panel (14). Thus, since the plural operation buttons (Bx) are arranged along the longitudinal direction or the lateral direction of the display panel (14), the operation buttons can be used easily and intuitively.

### Second Aspect of the Invention

The second aspect of the invention is a machine tool equipped with the above display device (10).

Inclusion of the display device (10) makes it possible to grasp an abnormality caused by a failure of the touch panel (16) or a human touch error without providing redundancy to the touch panel (16).

### Third Aspect of the Invention

The third aspect of the invention is an abnormality determination method for determining abnormality of a touch panel (16) which includes a plurality of nodes arranged in a matrix on a display panel (14) along the X direction and the Y direction intersecting the X direction to detect a touch position (Xm, Yn) in the X direction and the Y direction. This abnormality determination method includes: a display step (S1) of displaying a plurality of operation buttons (Bx) on the display panel (14) so as not to overlap each other in the X direction and the Y direction of the touch panel (16); and a determination step (S3) of examining, based on coordinate information indicating the coordinates on the touch panel (16) of each of the plurality of operation buttons (Bx), whether or not the operation button corresponding to the touch position (Xm) in the X direction coincides with the operation button corresponding to the touch position (Yn) in the Y direction, and determining that an abnormality has occurred when the two operation buttons do not coincide.

Thus, it is possible to grasp an abnormality caused by a failure of the touch panel (16) or a human touch error without providing redundancy to the touch panel (16).

The abnormality determination method may further includes a notification step (S5) of displaying a notice indicating occurrence of the abnormality on the display panel (14) when it is determined that the abnormality has occurred. Thereby, the user can recognize that it is a failure of the touch panel (16) when no touch mistake is made.

The abnormality determination method may further include: an output step (S4) of, when the operation button corresponding to the touch position (Xm) in the X direction coincides with the operation button corresponding to the touch position (Yn) in the Y direction, outputting to the outside an operation signal indicating that the operation button has been operated. Thereby, it is possible to execute a process assigned to the operation button that has been normally touched.

When it is determined that an abnormality has occurred and when one of the operation button corresponding to the touch position (Xm) in the X direction and the operation button corresponding to the touch position (Yn) in the Y direction is a specific operation button, the output step

(S4) may output to the outside an operation signal indicating that the specific operation button has been operated. As a result, the control assigned to the specific operation button can be executed to assure safe conditions even if an abnormality occurs due to a failure of the touch panel (16) or a human touch error.

The display step (S1) may display the plurality of operation buttons (Bx) in a first area (AR1) on the display panel (14) and one or more operation icons (Ix) in a second area (AR2) on the display panel (14), the second area (AR2) being arranged so as not to overlap the first area (AR1) with respect to each of the X direction and the Y direction. This configuration enables normal use the second area (AR2) of the touch panel (16) while grasping an abnormality caused by a failure of the touch panel (16) or a human touch error without applying redundancy to the touch panel (16) in the first area (AR1).

The display step (S1) may display one or more operation icons (Ix) on the display panel (14), separately from the plural operation buttons (Bx), and the abnormality determination method may further include an operation detecting step (S10) of detecting an operation by distinguishing the operation with the operation icons (Ix) and the operation with the operation buttons, based on the touch position (Xm, Yn). This configuration enables normal use the touch panel (16) while grasping abnormality without applying redundancy to the touch panel (16).

The present invention is not limited to the embodiments described above, and it goes without saying that the embodiments can be freely modified within a range that does not deviate from the essence and gist of the present invention as set forth in the appended claims.

What is claimed is:

1. A display device, comprising:
a display panel displaying an image;
a touch panel including a plurality of nodes arranged in a matrix on the display panel along an X direction and a Y direction intersecting the X direction and configured to detect a touch position in the X direction and the Y direction;
a display controller configured to display a plurality of operation buttons on the display panel so as not to overlap each other in the X direction and the Y direction of the touch panel;
a storage storing coordinate information indicating coordinates on the touch panel of each of the plurality of operation buttons; and
a determination unit configured to examine, based on the coordinate information stored in the storage, whether or not the operation button corresponding to the touch position in the X direction coincides with the operation button corresponding to the touch position in the Y direction and determine that an abnormality has occurred when the operation buttons do not coincide.

2. The display device according to claim 1, wherein the display controller causes the display panel to display a notice indicating occurrence of the abnormality when it is determined that the abnormality has occurred.

3. The display device according to claim 1, further comprising an output unit configured to, when the operation button corresponding to the touch position in the X direction coincides with the operation button corresponding to the touch position in the Y direction, output to outside an operation signal indicating that the operation button has been operated.

4. The display device according to claim 3, wherein, when it is determined that an abnormality has occurred and when one of the operation button corresponding to the touch position in the X direction and the operation button corresponding to the touch position in the Y direction is a specific operation button, the output unit outputs to the outside an operation signal indicating that the specific operation button has been operated.

5. The display device according to claim 1, wherein the display controller is configured to display the plurality of operation buttons in a first area on the display panel and one or more operation icons in a second area on the display panel, the second area being arranged so as not to overlap the first area with respect to each of the X direction and the Y direction.

6. The display device according to claim 1, wherein the display controller is configured to display one or more operation icons on the display panel, separately from the plurality of operation buttons,
the display device further comprising an operation detector configured to detect an operation by distinguishing the operation with the operation icons and the operation with the operation buttons, based on the touch position.

7. The display device according to claim 1, wherein:
the display panel has a rectangular configuration; and
the touch panel is placed in a manner that the plurality of operation buttons are arranged in a longitudinal direction or a lateral direction of the display panel.

8. A machine tool, comprising:
a display panel displaying an image;
a touch panel including a plurality of nodes arranged in a matrix on the display panel along an X direction and a Y direction intersecting the X direction and configured to detect a touch position in the X direction and the Y direction;
a display controller configured to display a plurality of operation buttons on the display panel so as not to overlap each other in the X direction and the Y direction of the touch panel;
a storage storing coordinate information indicating coordinates on the touch panel of each of the plurality of operation buttons; and
a determination unit configured to examine, based on the coordinate information stored in the storage, whether or not the operation button corresponding to the touch position in the X direction coincides with the operation button corresponding to the touch position in the Y direction and determine that an abnormality has occurred when the operation buttons do not coincide.

9. An abnormality determination method for determining abnormality of a touch panel which includes a plurality of nodes arranged in a matrix on a display panel along an X direction and a Y direction intersecting the X direction to detect a touch position in the X direction and the Y direction,
the abnormality determination method comprising:
a display step of displaying a plurality of operation buttons on the display panel so as not to overlap each other in the X direction and the Y direction of the touch panel; and
a determination step of examining, based on coordinate information indicating coordinates on the touch panel of each of the plurality of operation buttons, whether or not the operation button corresponding to the touch position in the X direction coincides with the operation button corresponding to the touch position in the Y direction, and determining that an abnormality has occurred when the operation buttons do not coincide.

10. The abnormality determination method according to claim 9, further comprising a notification step of displaying a notice indicating occurrence of the abnormality on the display panel when it is determined that the abnormality has occurred.

11. The abnormality determination method according to claim 9, further comprising an output step of, when the operation button corresponding to the touch position in the X direction coincides with the operation button corresponding to the touch position in the Y direction, outputting to outside an operation signal indicating that the operation button has been operated.

12. The abnormality determination method according to claim 11, wherein when it is determined that an abnormality has occurred and when one of the operation button corresponding to the touch position in the X direction and the operation button corresponding to the touch position in the Y direction is a specific operation button, the output step outputs to the outside an operation signal indicating that the specific operation button has been operated.

13. The abnormality determination method according to claim 9, wherein the display step displays the plurality of operation buttons in a first area on the display panel and one or more operation icons in a second area on the display panel, the second area being arranged so as not to overlap the first area with respect to each of the X direction and the Y direction.

14. The abnormality determination method according to claim 9, wherein the display step displays one or more operation icons on the display panel, separately from the plural operation buttons,
the abnormality determination method further comprising an operation detecting step of detecting an operation by distinguishing the operation with the operation icons and the operation with the operation buttons, based on the touch position.
